(19) United States
(12) Patent Application Publication
(10) Pub. No.: US 2007/0237312 A1
(43) Pub. Date: Oct. 11, 2007

(54) Communications Device

(75) Inventors: Jesus Fernando Guitarte Perez, Munchen (DE); Carlos Lucas, Zaragoza (ES); Klaus Lukas, Munchen (DE)

Correspondence Address: BELL, BOYD & LLOYD, LLP, P.O. BOX 1135, CHICAGO, IL, 60690, US

(73) Assignee: Siemens Aktiengesellschaft, Munchen (DE)

(21) Appl. No.: 11/571,930

(22) PCT Filed: Jun. 21, 2005
(86) PCT No.: PCT/EP05/52871

§ 371 Date: Jan. 10, 2007

(30) Foreign Application Priority Data
Jul. 15, 2004 (DE) 10 2004 034 288.1

(51) Int. Cl. H04M 11/00

(52) U.S. Cl. 379/93.23

(57) ABSTRACT

The present disclosure relates to a communications device including a memory unit for storing image data and telephone book entries and a processor unit. Said processor unit is configured to favor image data containing information that describes faces.

### FIELD OF TECHNOLOGY

The present disclosure relates to a communications device, especially a mobile telephone, a computer or a portable computer.

### BACKGROUND

Known mobile telephones have for many years now been equipped with an electronic telephone book stored in a memory. The telephone book entries of the electronic telephone book are in such cases assigned to different subscriber data: The telephone number of a subscriber, the name of a subscriber, the address of a subscriber, the e-mail address of a subscriber etc.

In particular people using their mobile telephone for business purposes and contacting large numbers of people frequently cite as a disadvantage of known mobile telephones the fact that a telephone book entry, once stored in their mobile telephone, can only be found again with difficulty with reference to the name of the person sought. This is because it is known that the human memory only has a comparatively low ability to recall names.

For this reason mobile telephones have already been proposed in which the telephone book entries of an electronic telephone book can also be assigned to photos of the corresponding persons. This exploits the knowledge that the human memory has a greater ability to recall images, especially images of faces, than names.

However the problem still arises in such cases that the assignment of photos (image data) to the corresponding persons for telephone book entries is organized in a complex manner and is not designed very intuitively, so that people, who, for example, put 50 new entries into their telephone book during one day at a trade fair, dispense with the assignment of photos to the corresponding telephone book entries even though their mobile telephone would offer them this function.

### SUMMARY

Under an exemplary embodiment, a communications device is disclosed which makes possible a simplified assignment of image data to telephone book entries.

The embodiment is thus based on the idea of classifying received or stored image data, especially one or more photos, depending on whether the image data describes a face or not. The classification result is then utilized when the image data is assigned to telephone book entries in order to favor the handling, provision or processing of image data containing face description data. The term “telephone book entry” for the purposes of the embodiment also refers to address book entries.

The classification can in this case be undertaken both automatically after the image data is received, via a multimedia or short message service for example, and also automatically after the first time that the image data is stored. Likewise the embodiment also covers the case in which the classification of image data is undertaken after a corresponding user entry, or automatically during the entry or processing of a telephone book entry or of image data. Face description data includes all types of data which are suitable for describing an image of a face or a person. Preferably the result of the classification process contains not only the information as to whether the classified image data contains a face or not, but also contains additional information about the location at which the face description data and is to be found within the image data or about the size or the quality of such data. This additional information is preferably used to extract face description data from the image data and preferably for example to show it in enlarged or highlighted form.

Also disclosed is the provision for image data which contains face description data to be automatically displayed to a user of the communications device as part of the process of storing a telephone book entry.

Thus a user can, for example, during menu-guided entry or modification of a telephone book entry, be provided with a series of image data for assignment to the telephone book entry at a specific point of the input process, in which case image data containing the face description data is offered to the user first, or the user is exclusively offered image data which contains face description data. The final assignment of image data to a telephone book entry can then be undertaken by the user confirming his or her selection of offered image data, for example an offered photo.

In another embodiment, image data that is received in a communications device, for example via a short message service or a multimedia service from a sender, contains face description data, to be automatically assigned to the telephone book entry which corresponds to the sender of the image data. For this purpose a telephone book entry for the name or for the telephone number of the sender should already exist.

Preferably the user is requested, before a final assignment of image data to the telephone book entry of the sender, to enter a corresponding confirmation.

The image data may also describe a plurality of faces—that is, a plurality of photos of one face or of one person respectively—which may be assigned to one telephone book entry. When an incoming call is signaled from a sender to whom a telephone book entry is assigned the plurality of photos is then preferably displayed automatically as a sequence of photos.

It is also within the framework of the present disclosure for the image data to include video data or for the face description data to be extracted from video data.

Accordingly, telephone book entries of a telephone book stored electronically in a communications device can be enabled to be assigned face description data in a simple and intuitive manner. The indirect effect of this is that it is made possible in a simple manner for a user to set up his or her electronic telephone book so that he or she—supported by his or her visual memory—is in a position to easily distinguish from each other a plurality of different persons and corresponding telephone book entries in an electronic telephone book and to find them again.

The exemplary communications device has a memory for (electronic) photos and subscriber data in the form of telephone book entries. The processor device analyzes received or stored or buffered photos to the extent of establishing whether at least one face or at least one person is depicted in the photos. A photo on which at least one face of at least one person is depicted is given preference in handling, given preference in processing and given preference in being displayed to a user or given preference in being displayed to a user for selection—especially within the context of modifying an existing telephone book entry or making a new one.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 illustrates a block diagram of a mobile telephone according to an exemplary embodiment.

### DETAILED DESCRIPTION

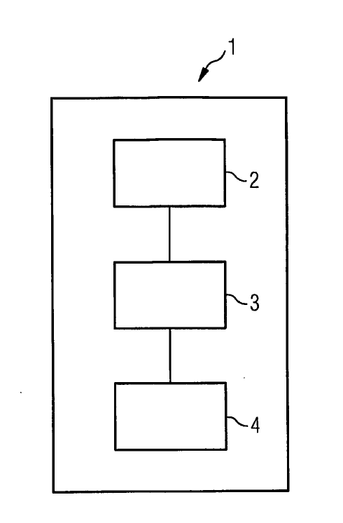

An exemplary mobile telephone 1 is shown in FIG. 1 as a communications device, including a display device 2, a processor device 3, and a memory device 4.

Processor device 3 is programmed and linked to display device 2, memory device 4 and an input device not shown in the diagram, for example a keyboard, in such a way that a user, with the assistance of the input device and the display device, can input telephone book entries into the mobile telephone, especially into the memory device 4, and can retrieve them from there.

Stored in the memory device 4 is the data of a telephone book entry, such as subscriber name, subscriber telephone number, subscriber address etc.

Display device 2, which can be embodied as a graphics display, is used for displaying the telephone book entries or parts of telephone book entries. In addition the display device is also used to display image data (photos), especially face description data (photos of people or faces) which are assigned to a telephone book entry or can be assigned to such an entry.

This image data, especially the face description data, is stored in the memory device 4 or in another memory device provided additionally for this purpose. Before the image data is stored, especially the face description data, this data can have been transmitted via a receiver module, not shown in the drawing, over any wireless or other, communication channel to the communications device.

Processor device 3 is programmably set up as to enable it to execute the method described below with the communications device.

In the exemplary method, all, or at least a part of the image data stored in the memory device, is subjected automatically or after a corresponding user entry to a classification process. The classification process can contain picture analysis methods known per se which are suitable for recognizing faces or persons within image data. The classification method implemented in the form of programs can be executed by the processor device or by another processor. The image data (a photo or in number of photos) is or are provided with a corresponding tag—depending on whether they contain face description data (picture of a face or the person) or not.

Within the framework of a menu-controlled telephone book entry/input sequence, image data is displayed automatically or after a corresponding user entry to the user of the mobile telephone, and the image data can be assigned to the telephone book entry currently being entered or processed. The image data offered to the user in this case for assignment however preferably does not include all the image data stored in the memory device but only that image data which contains face description data. As an alternative, although the user is still offered image data for assignment which does not include any face description data, image data which includes face description data is offered first.

Within the framework of the further telephone book entry input sequence, the user can then assign to the telephone book entry through corresponding input commands a record (one photo), or a number of image data records (a number of photos) which each describe a photo of a face or of a person.

For an incoming call from a sender who corresponds to a telephone book entry at the mobile telephone the image data record, that is the photo, is then automatically displayed on the display device which is assigned to the corresponding telephone book entry of the sender. For a case in which the telephone book entry is assigned to a plurality of photos, a sequence of these photos is automatically presented on the display device of the mobile telephone and the display can repeat them in a cycle.

An alternate embodiment makes provision for received image data, which for example is transmitted via a mobile radio network and received by the mobile telephone, to be automatically subjected to the above-mentioned classification process after being received by the mobile telephone. The result of the classification process is then linked again in the form of a tag to the image data so that the image data is subdivided as a result into two groups of image data:

1. Image data which does not contain any face description data and

2. Image data which contains face description data.

According to this classification the image data, including tag, is stored in the memory device.

Preferably, received image data which contains face description data is automatically assigned to the telephone book entry of the subscriber (sender) who has sent the image data to the communications device. To this end it is possible for the telephone number of the sender transmitted with the image data to be compared with telephone book entries stored in the electronic telephone book of the communications device. The image data sent by the sender which contains face description data is then automatically assigned to the telephone book entry which belongs to the telephone number transmitted.

In another alternate embodiment, the face description data which is contained in the image data is detected and preferably stored or displayed. For example the face description data can be stored in addition or exclusively or the face description data can be shown or exclusively highlighted or enlarged in relation to the remaining image data—in the sense of an automatic zoom onto the face area of the image data. For example the face is cut out from a photo, on which a face is depicted, and only this section is stored assigned to the telephone book entry. For example only the section with the face is shown if the image data is shown or processed as part of a telephone book entry.

Yet another alternate embodiment makes provision for image data to be assigned a storage date, and, during an assignment of image data to telephone book entries, for image data with a more recent storage date to be favored.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1-7. (canceled)

8. A communications device, comprising:
a memory device for storing image data and telephone book entries; and
a processor device that classifies image data depending on whether the image data contains face description data or not, wherein when image data is assigned to telephone book entries, image data which contains face description data is favored.

9. The communications device as claimed in claim 8, wherein image data that contains face description data is displayed automatically to a user of the communications device within the framework of storage of the telephone book entries.

10. The communications device as claimed in claim 9, wherein image data received from a sender which contains face description data is automatically assigned to the telephone book entry which corresponds to the sender of the image data.

11. The communications device as claimed in claim 9, wherein a specific telephone book entry is assigned image data for description of a plurality of faces, and a plurality of faces assigned to a telephone book entry are displayed automatically in turn as a sequence of faces, if an incoming call which is assigned to the telephone book entry is signaled.

12. The communications device as claimed in claim 8, wherein the image data is video data.

13. The communications device as claimed in claim 8, wherein the face description data is extracted from image data and favored for display.

14. The communications device as claimed in claim 12, wherein face description data is extracted from video data and favored for display.
